(19) United States
(12) Patent Application Publication
(10) Pub. No.: US 2006/0139929 A1
(43) Pub. Date: Jun. 29, 2006

(54) Flashing pen stand operatable based upon user interaction

(75) Inventor: J. Robert Gluck, Lawrence, NY (US)

Correspondence Address: GREENBLUM & BERNSTEIN, P.L.C., 1950 ROLAND CLARKE PLACE, RESTON, VA, 20191, US

(73) Assignee: ROBERT GORDON INDUSTRIES, Ltd., Lynbrook, NY (US)

(21) Appl. No.: 11/022,751

(22) Filed: Dec. 28, 2004

(51) Int. Cl. F21V 23/04

(52) U.S. Cl. 362/276

(57) ABSTRACT

An office product that includes a light, an item holder, and a sensor that detects a change of presence of an item in the item holder. Moreover, the office product includes a controller that is structured and arranged to operate the light at least when the sensor detects the change of presence of the item. The instant abstract is neither intended to define the invention disclosed in this specification nor intended to limit the scope of the invention in any way.

### BACKGROUND OF THE INVENTION

1. Field of the Invention

The present invention relates to a partially transparent or translucent office product having a light associated therewith along with an operative feature that operates the light. The operative feature operates the light based upon user interaction with the office product.

2. Discussion of Background Information

It is known to have a pen stand that is configured to hold and/or store a pen in a useful orientation such that the pen is easily grasped for use. However, a typical conventional pen stand does not have any additional functionality other than holding the pen.

### SUMMARY OF THE INVENTION

The instant invention relates to an office product having a partially transparent or translucent pen stand having a light associated therewith along with an operative feature that operates the light. The operative feature operates the light based upon user interaction with a pen that is positioned on the pen stand. Moreover, the operative feature can operate the light for a limited time.

One aspect of the present invention includes an office product that includes a light, an item holder, and a sensor that detects a change of presence of an item in the item holder. Moreover, the office product includes a controller that is structured and arranged to operate the light at least when the sensor detects the change of presence of the item.

In a further aspect of the present invention, the item holder can include a penholder and the item can include a pen. Moreover, the sensor can be a switch and the switch is one of opened or closed to detect the change of presence of the pen and the switch is arranged in the penholder. Additionally, the light can be a LED and the light can be arranged inside the item holder. Furthermore, the item holder can include a solid portion that can be one of at least partially transparent and translucent. Moreover, the light can be a LED and the light is arranged inside the solid portion. Additionally, the controller can include an electrical circuit. Furthermore, the controller can operate the light for a predetermined time period. Moreover, the controller can repeatedly operate the light for a predetermined time period. Additionally, the pen holder can include a solid portion that is one of at least partially transparent and translucent and the item holder can include a magnet structured and arranged to hold the pen. Moreover, the item holder can further include a solid portion that is one of at least partially transparent and translucent, a magnet structured and arranged to hold the pen, and a button structured and arranged to contact the pen and the switch.

Yet another aspect of the present invention includes a method of operating an office product. The method includes one of removing an item from or placing an item onto the office product and operating a light associated with the office product for a predetermined time in response to one of removing or placing the item.

A further aspect of the invention can include sensing when a first switch is one of opened or closed when a user removes or places the item onto the office product and the item can include a pen and the office product can include a penholder. Furthermore, the item holder can include a penholder and the item can include a pen. Moreover, the light can be a LED and the light can be arranged inside the office product. Additionally, the office product can be one of at least partially transparent and translucent. Furthermore, an office product can operate according to the method noted above.

Another aspect of the present invention includes an office product that includes a light, a solid portion that is one of at least partially transparent and translucent, and an item holder positioned on the solid portion. Moreover, the office product includes a sensor that detects a change of presence of an item in the item holder and a controller that is structured and arranged to operate the light at least when the sensor detects the change of presence of the item. Additionally, the sensor is a switch and the switch is one of opened or closed to detect the change of presence of the item.

In a further aspect of the present invention, the item can be a pen, the light can be a LED, and the light can be arranged inside the solid portion. Moreover, the controller can include an electrical circuit and the controller can operate the light for a predetermined time period. Additionally, the item holder can be a magnet structured and arranged to hold a pen and a button that operatively contacts the pen and the switch.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a perspective view of an exemplary embodiment of the present invention;

FIG. 2 shows an exemplary side view of the internal components of the FIG. 1 aspect of present invention; and

FIG. 3 shows an exemplary circuit diagram according to an embodiment of the present invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

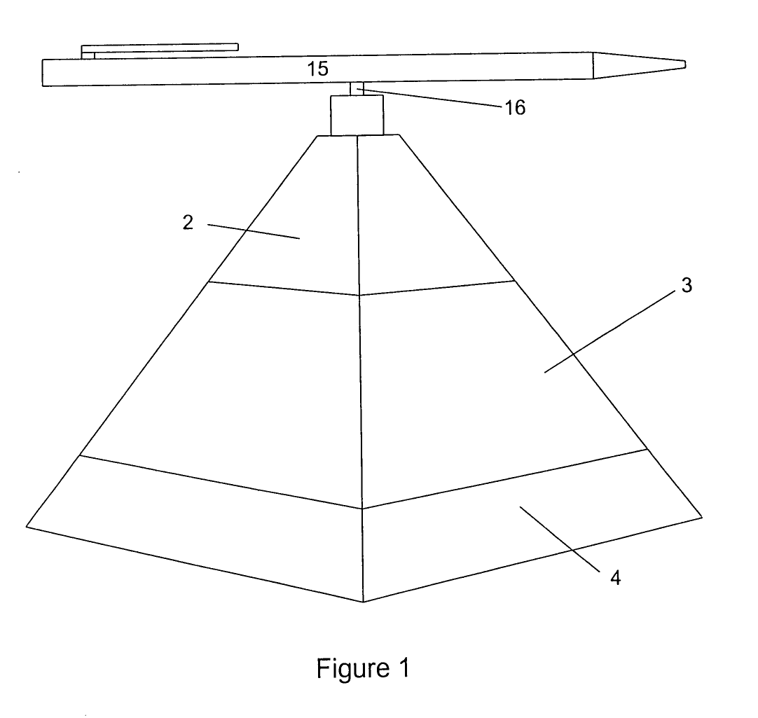

FIG. 1 shows an exemplary embodiment of the office product such as a flashing pen stand that includes a solid portion 3 that takes the form of a triangular prism or a pyramid shape. Although FIG. 1 shows a particular exemplary shape, it would be within the spirit and scope of the present invention to use any known solid shape. For example, any known polyhedron would be within the spirit and scope of the present invention including a tetrahedron, hexahedron, octahedron, dodecahedron, and icosahedron. Moreover, a cone, cylinder, sphere, any other rounded solid, or any combination of a polyhedron and a rounded solid would also be contemplated in the present invention. Furthermore, any animal-like, human-like, vehicle-like, building-like shape or any other shape that characterizes a shape of an existing object is also contemplated by the present invention.

As further shown in the exemplary embodiment of FIG. 1, the pen stand includes a base 4 that at least forms part of a bottom of the pen stand and supports the solid portion 3. In an exemplary aspect of the present invention, the base 4 is made of a black matte acrylic. However, it is contemplated that any suitable color, finish, or material is within the spirit and scope of the present invention. Positioned at the top of the solid portion 3 is a pen attachment 16. The pen attachment 16 is configured to allow a pen 15 to be removably held at an upper side of the pen attachment 16.

In an exemplary aspect of the present invention, the solid portion 3 is at least partially formed of a transparent or translucent material that will allow light to be at least partially transmitted therethrough. In a particular aspect of the present invention, the solid portion 3 is formed of a transparent acrylic material. However, it is within the spirit and scope of the present invention to use any known solid material or combination of materials for use with the solid portion 3 such as glass, plexi-glass, synthetic material, and crystal. Moreover, it is contemplated that the transparent or translucent material of the solid portion 3 can be formed with any given color.

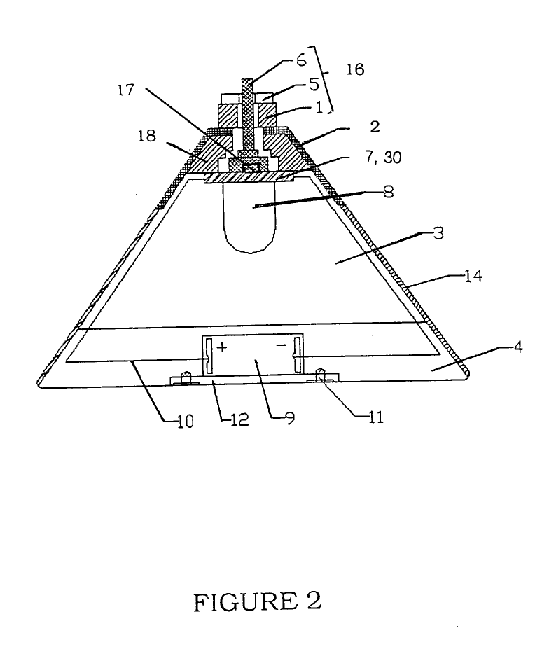

As shown in the exemplary embodiment of FIG. 1, the pen attachment 16 supports a pen 15 that is held above the solid portion 3. In one aspect of the present invention shown in FIG. 2, the pen attachment 16 includes a button 6. The button 6 is pillar-shaped and extends from a hollow portion of the solid portion 3. The top part of button 6 extends above the top of the solid portion 3 and can be formed of a non-metallic material or preferably with a metallic material. The pen attachment 16 also includes a ring-shaped hollow magnet 1 that the button 6 extends through. Mounted on the magnet 1 is an arc-shaped structure 5 having a hole that allows the button 6 to extend therethrough. With this arrangement, a pen 15 that is made of a ferrous material, for example, will be attracted towards ring-shaped magnet 1. The button 6 will prevent the pen 15 from contacting the ring-shaped magnet 1 and will hold the pen 15, via magnetic attraction, directly above the magnet 1. In this way, the pen 15 is securely positioned on the pen attachment 16. However, it would be within the spirit and scope of the present invention to use any type of penholder 16 that will hold a pen 15 with respect to the solid portion 3. For example, the pen attachment 16 can take any known form including a cylindrical hole or some other groove-shaped support surface.

The above-noted arrangement of the pen 15, the magnet 1, and the button 6 has the additional feature of allowing the pen 15 to rotate with respect to the button 6, magnet 1, and the solid portion 3. More specifically, magnet 1 attracts pen 15 and will hold pen 15 onto a top of button 6. A user can then rotate or spin pen 15 to create an entertaining helicopter-like effect.

As further shown in the exemplary embodiment of FIG. 2, the pen attachment 16, which includes button 6, arc-shaped structure 5, and magnet 1, is positioned adjacent to a flash control part 2. In particular, the arc-shaped structure 5 is positioned on the magnet 1 which is positioned on the flash control part 2. Each of these components can be held together with any known fastener such as for example an adhesive. The button 6 extends through a hollow portion of each of the arc-shaped structure 5, the magnet 1, and the flash control part 2. In this regard, the top surface of the button 6 is smooth enough and the attraction of the magnet 1 is such that the pen 15 will rotate as noted above.

The flash control part 2 can also include support material 18 for at least supporting the components of the flash control part 2 from damage and/or insulating the components of the flash control part 2. The support material 18 can be formed from, in part, Acrylonitrile Butadiene Styrene (ABS). However, any known material that provides component support is with the scope and spirit of the present invention. Moreover, the surface of the flash control part 2 has an upside down basin shape. A center of the surface of the flash control part 2 is made of chrome and includes a hole for the button 6 to extend therethrough.

As further shown in the exemplary embodiment of FIG. 2, in the base of solid 3 there is a space for a battery box 12. The battery box 12 can be fixed in the base 4 and/or solid portion 3 by any known mechanical fastener or fastening material. For example, the battery box 12 can be held by two screws 11. However, it would be within the spirit and scope of the present invention to use any known mechanical fastener. From the bottom of the base 4, the battery box 12 can be opened to change one or more batteries 9. However, it is within the scope and spirit of the present invention to position the battery box in any portion of the present invention. Moreover, any components of the pen holder can be arranged in the battery box 12 or alternatively, all of the components of the battery box 12 can arranged in other locations of the pen holder and the battery box 12 eliminated.

As further shown in the exemplary embodiment of FIG. 2, the flash control part 2 includes a printed circuit board 7. The printed circuit board 7 is fixed under support material 18. The printed circuit board 7 can, in one aspect of the present invention, be connected through at least two wires 10 to the battery box 12 so as to be powered. The wires 10 that connect the printed circuit board 7 with battery box 9 are placed along two sides of the solid portion 3. The solid portion 3 can include chrome press strips 14 on the sides of the solid portion 3 so that the wires 10 cannot be seen from outside. An integrated circuit 30 is placed adjacent to the printed circuit board 7 and operatively connected therewith.

Operatively connected to the integrated circuit 30 and printed circuit board 7 is a light 8. The light 8 can be placed in any portion of the solid portion 3 to allow light to shine therethrough. In the aspect of the present invention shown in FIG. 2, the light 8 is placed in a center of a bottom of the flash control part 2 and extends into the transparent solid portion 3.

In the present invention the light 8 can be, for example only, a light emitting diode (LED), a neon light, an incandescent light bulb, or any other suitable light-emitting device. Furthermore, the light 8 can include plural lights and additionally the light 8 can be one or more colors.

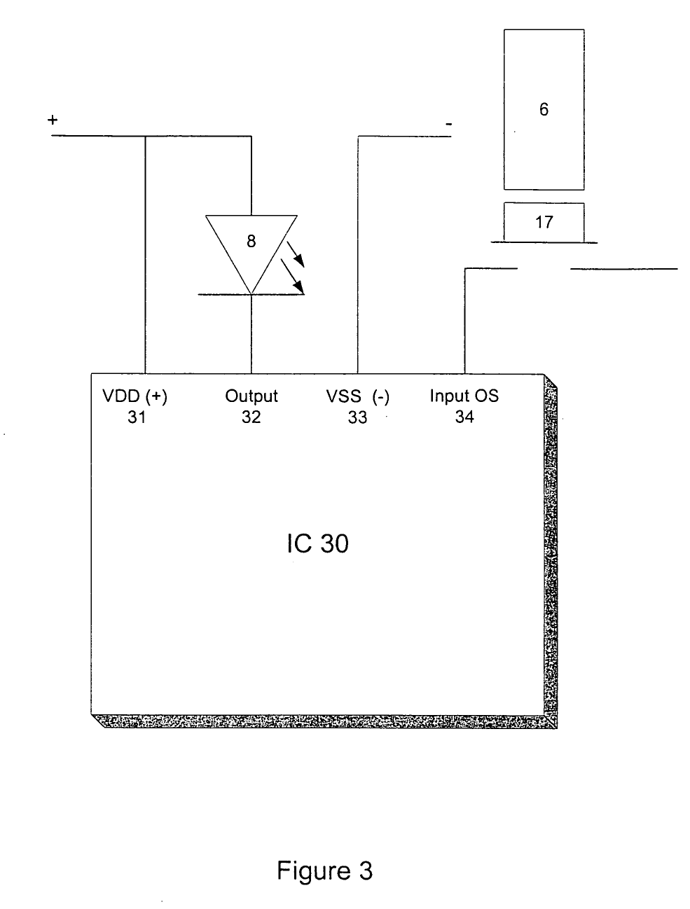

The light 8 is activated in part due to operation of a sensor 17. The sensor 17 senses interaction by the user with the penholder and can be implemented as a switch that detects movement of the penholder components. For example, the sensor 17 that is implemented as a switch is operatively attached to a lower portion of the button 6. The button 6 supports the pen 15 and interaction with the pen 15 by a user, such as placing the pen on button 6 or removing the pen 15 from the button 6 will cause the button 6 to move. The sensor 17 implemented as a switch is biased open or closed such that movement of the button 6 will close or open the switch implementation of the sensor 17. In a preferred aspect of the present invention shown in FIG. 3, sensor 17 implemented as a switch and/or button 6 is biased such that when the pen 15 is removed from the button 6, the sensor 17 will indicate user interaction. More specifically, the weight of the pen 15 removed from button 6 will trigger the sensor 17 (note that FIG. 3 merely shows the interaction of the various parts and is not drawn to scale). Alternatively, the sensor 17 can be a sensor that detects movement of the entire penholder or senses motion near the pen holder. For example, the sensor 17 can include a mercury switch that senses movement of the penholder by movement of a ball of mercury that contacts two or more electrical contacts to complete a switch circuit. It should be apparent that it is within the spirit and scope of the present invention to use any type of sensor that can sense when there is interaction by a user with the penholder.

Next, the associated circuitry of the sensor 17 will be discussed. The sensor 17 includes mechanical and electrical components that enable the light 8 to illuminate in response to the sensor 17 sensing interaction with the user. It should be apparent that it is within the spirit and scope of the present invention to use any electrical circuit that uses input from a switch or sensor 17 and in response thereto outputs a signal to operate the light 8 such as an, application specific integrated circuit (ASIC), analog circuit, smart card, digital circuit, integrated circuit, or microprocessor. The electrical circuit in response to receiving the sensor 17 input, will drive or provide electrical power to the light 8. Additionally, the electrical circuit can drive or power the light 8 in such a manner that can be entertaining to the user and will drive or power the light 8 for a limited time in order to conserve power. For example, the light 8 can flash in an entertaining manner, flash different colors, or multiple lights can flash at different times and colors.

According to an exemplary embodiment of the present invention, an integrated circuit (IC) 30, e.g. Model No. PCB-STP-01 from Golden Right Ltd. of Taiwan, is illustrated in FIG. 3, can be used as the electrical circuit. However, it is with the spirit and scope of the present invention to use any circuit that provides the desired timing functions, such as the model 555 timer. The IC 30 includes a voltage drain drain (VDD) 31 that is connected through line 34 to one or more batteries 9. The VDD 31 is the positive power connection for providing power to the IC 30. The IC 30 also includes an output 32 for completing the circuit with the light 8. For example as shown in FIG. 3, the output 32 provides power to the light 8, e.g. an LED. The IC 30 also includes a voltage for substrate and sources (VSS) 33 for providing power to the IC 30 by connection to a negative terminal of the one or more batteries 9. The IC 30 includes an input 34 that is a voltage offset (OS). The input 34 is connected to the switch 17 and in turn, the switch 17 is connected to either a positive or negative terminal of the one or more batteries 9.

Next, the operation of the IC 30 will be discussed. When an appropriate power supply is connected to the VDD 31 and the VSS 33, the IC 30 will be operationally powered. When the sensor 17 implemented as a switch is either closed or opened for a predetermined time, the input 34 will be recognized as an offset in the voltage. The IC 30 will then send power through the output 32 to illuminate the light 8. In an aspect of the present invention, the IC 30 will illuminate the light 8 after receiving input from the sensor 17 at the input 34. In a particular embodiment, the IC 30 will repeatedly provide illuminate the light 8 in order to make the light 8 blink. For example, the power can be applied to the light 8 for ½ second and removed for ½ second for 20 seconds. However, it should be apparent that any number of blinks, having any blink length and/or variable blink length would be within the spirit and scope of the present invention.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An office product comprising:
a light;
an item holder;
a sensor that detects a change of presence of an item in the item holder; and
a controller that is structured and arranged to operate the light at least when the sensor detects the change of presence of the item.

2. The office product according to claim 1, wherein the item holder comprises a penholder and the item comprises a pen.

3. The office product according to claim 2, wherein the sensor is a switch and the switch is one of opened or closed to detect the change of presence of the pen and the switch is arranged in the penholder.

4. The office product according to claim 1, wherein the light is a LED and the light is arranged inside the item holder.

5. The office product according to claim 1, wherein the item holder comprises:
a solid portion that is one of at least partially transparent and translucent.

6. The office product according to claim 5, wherein the light is a LED and the light is arranged inside the solid portion.

7. The office product according to claim 1, wherein the controller comprises an electrical circuit.

8. The office product according to claim 1, wherein the controller operates the light for a predetermined time period.

9. The office product according to claim 1, wherein the controller repeatedly operates the light for a predetermined time period.

10. The office product according to claim 2, wherein the pen holder comprises a solid portion that is one of at least partially transparent and translucent; and
wherein the item holder comprises a magnet structured and arranged to hold the pen.

11. The office product according to claim 2, wherein the item holder further comprises:
a solid portion that is one of at least partially transparent and translucent;
a magnet structured and arranged to hold the pen; and
a button structured and arranged to contact the pen and the switch.

12. A method of operating an office product comprising:
one of removing an item from or placing an item onto the office product; and
operating a light associated with the office product for a predetermined time in response to one of removing or placing the item.

13. The method according to claim 12 further comprising:
sensing when a first switch is one of opened or closed when a user removes or places the item onto the office product,
wherein the item comprises a pen and the office product comprises a penholder.

14. The method according to claim 12, wherein the item holder comprises a penholder and the item comprises a pen.

15. The method according to claim 12, wherein the light is a LED and the light is arranged inside the office product.

16. The method according to claim 12, wherein the office product is one of at least partially transparent and translucent.

17. An office product operating according to the method of claim 12.

18. An office product comprising:
a light;
a solid portion that is one of at least partially transparent and translucent;
an item holder positioned on the solid portion;
a sensor that detects a change of presence of an item in the item holder; and
a controller that is structured and arranged to operate the light at least when the sensor detects the change of presence of the item,
wherein the sensor is a switch and the switch is one of opened or closed to detect the change of presence of the item.

19. The office product according to claim 18 wherein the item comprises a pen, the light comprises a LED, and the light is arranged inside the solid portion.

20. The office product according to claim 19, wherein the controller comprises an electrical circuit and the controller operates the light for a predetermined time period.

21. The office product according to claim 18, wherein the item holder comprises a magnet structured and arranged to hold a pen and a button that operatively contacts the pen and the switch.
